(19) United States
(12) Patent Application Publication
(10) Pub. No.: US 2023/0302317 A1
(43) Pub. Date: Sep. 28, 2023

(54) INTEGRATED FIRE SUPPRESSION IN MOBILE LITHIUM-ION BATTERY ARRAY

(71) Applicant: STEWART & STEVENSON LLC, Houston, TX (US)

(72) Inventors: Donald KOBS, Houston, TX (US); Ryan LOOFS, Cedar Park, TX (US); Chris HARVELL, Houston, TX (US); David HANSON, Houston, TX (US); Adam LAMBERTUS, Houston, TX (US)

(21) Appl. No.: 18/124,696

(22) Filed: Mar. 22, 2023

Related U.S. Application Data
(60) Provisional application No. 63/323,796, filed on Mar. 25, 2022.

(51) Int. Cl. A62C 37/36; H01M 10/0525; A62C 3/00; A62C 35/02; A62C 35/68; A62C 37/40; A62D 1/00

(52) U.S. Cl. CPC A62C 37/04; H01M 10/0525; A62C 3/002; A62C 35/026; A62C 35/68; A62C 37/40; A62D 1/0014; A62D 1/0042

(57) ABSTRACT

A system includes an energy storage system (ESS), having battery pods and one or more battery cells disposed within the battery pods. The system also includes an ESS trailer, the ESS mounted on the ESS trailer. Also, the system includes a water spray subsystem. The water spray subsystem includes a plurality of sprinkler nozzles mounted within the battery pods and a first fluid connection fluidly connecting the sprinkler nozzles to a pump package. In addition, the water spray subsystem includes a second fluid connection, fluidly connecting the pump package to a water storage supply. The system includes a dry chemical spray subsystem, which has a dry chemical supply vessel, the dry chemical supply vessel mounted to the ESS trailer and a plurality of dry chemical distribution nozzles mounted within the battery pods, the dry chemical distribution nozzles fluidly connected to the dry chemical supply vessel by dry chemical distribution piping.

### CROSS-REFERENCE TO RELATED APPLICATIONS

This application is a nonprovisional application which claims priority from U.S. provisional application No. 63/323,796, filed Mar. 25, 2022, which is incorporated by reference herein in its entirety.

### TECHNICAL FIELD/FIELD OF DISCLOSURE

The present disclosure relates generally to energy storage, and specifically to fire suppression for mobile energy storage systems.

### BACKGROUND OF THE DISCLOSURE

Lithium-ion battery thermal runaway occurs when one or more cells reaches an elevated temperature due to thermal failure, mechanical failure, or internal/external short circuiting. At the elevated temperature, the cells begin exothermic decomposition. In certain circumstances, the heating rate of the cell may become greater than the rate at which heat can be dissipated. The cell temperature then rises uncontrollably and may spread to other cells.

### SUMMARY

A system is disclosed. The system includes an energy storage system (ESS), the ESS including battery pods and one or more battery cells disposed within the battery pods. The system also includes an ESS trailer, the ESS mounted on the ESS trailer. In addition, the system includes a water spray subsystem. The water spray subsystem includes a plurality of sprinkler nozzles, the sprinkler nozzles mounted within the battery pods and a first fluid connection, the first fluid connection fluidly connecting the sprinkler nozzles to a pump package. In addition, the water spray subsystem includes a second fluid connection, the second fluid connection fluidly connecting the pump package to a water storage supply. The system additionally includes a dry chemical spray subsystem. The dry chemical spray subsystem includes a dry chemical supply vessel, the dry chemical supply vessel mounted to the ESS trailer and a plurality of dry chemical distribution nozzles mounted within the battery pods, the dry chemical distribution nozzles fluidly connected to the dry chemical supply vessel by dry chemical distribution piping.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic of the water spray subsystem in combination with the self-contained water pumping subsystem consistent with at least one embodiment of the present disclosure.

FIG. 2 is a schematic of the battery pod distribution subsystem consistent with a at least one embodiment of the present disclosure.

FIG. 3 is schematic of the dry chemical subsystem consistent with at least one embodiment of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

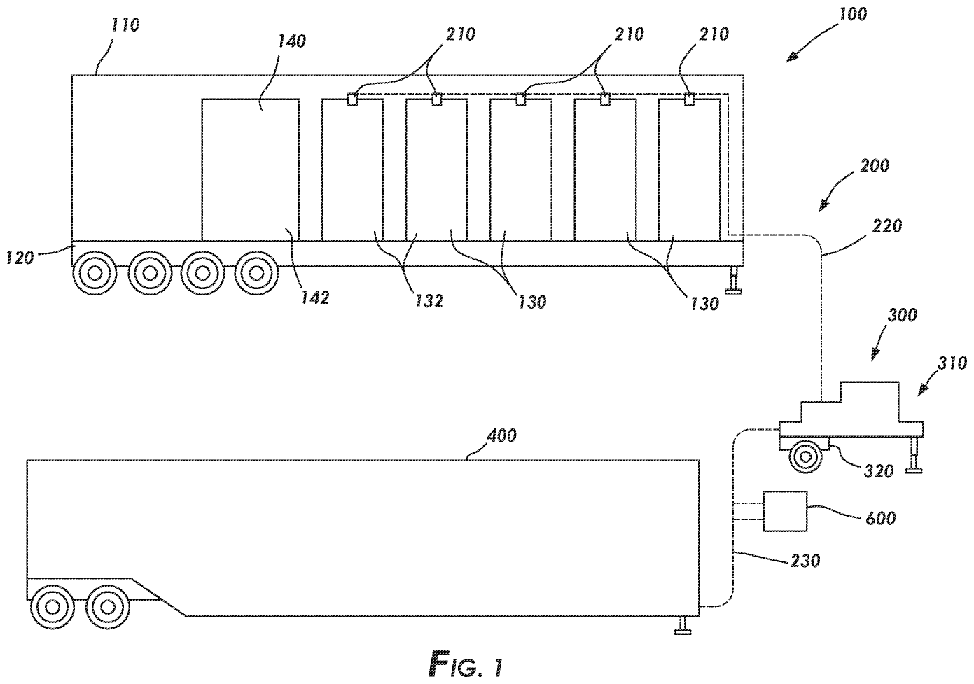

FIG. 1 depicts a portion of ESS system 100. ESS system 100 includes energy storage system (ESS) 110. ESS 110 may be mounted on ESS trailer 120 and may include battery pods 130 mounted on ESS trailer 120. Battery pods 130 may contain one or more battery cells 132. In certain embodiments, battery cells 132 may be lithium-ion batteries, although other types of battery cells 132 may be included in ESS system 100. ESS 110 may further include power electronics 140 mounted within power electronics compartment 142 of ESS trailer 120.

FIG. 1 further depicts water spray subsystem 200. Water spray subsystem 200 may include sprinkler nozzles 210. Sprinkler nozzles 210 may be mounted within battery pods 130. In some embodiments, each battery pod 130 may include a sprinkler nozzle 210. In other embodiments, each battery pod 130 may have a plurality of sprinkler nozzles 210. Sprinkler nozzles 210 may be fluidly connected to pump package 300, such as through first fluid connection 220. First fluid connection 220 may be piping or a hose, for example. Pump package 300 may include pump 310. In some embodiments pump package 300 may be mounted on pump package trailer 320. Pump 310 may be fluidly connected through second fluid connection 230 to water storage supply 400. Second fluid connection 230 may be piping or a hose, for example. In certain embodiments, water storage supply 400 may be a tank trailer. In other embodiments, water storage supply 400 may be a stationary tank, a skid-mounted tank, a drop tank, or a permanent water supply source such as one provided by a local municipality, water pipeline or natural water supply source. When pump package 300 is mounted on pump package trailer 320 and water storage supply 400 is a tank trailer, water spray subsystem 200 is mobile.

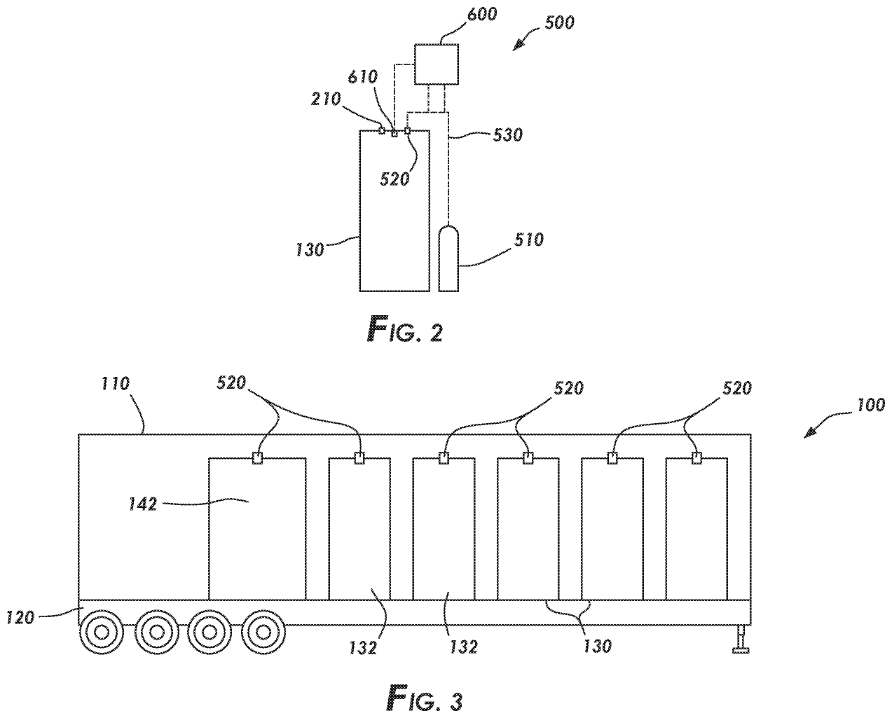

FIG. 2 depicts dry chemical spray subsystem 500. Dry chemical spray subsystem 500 may include dry chemical supply vessel 510. Dry chemical supply vessel 510 may be mounted on ESS trailer 120. Dry chemical supply vessel 510 may include a dry chemical typically used for fire suppression, such as, for example, dodecafluoro-2-methylpentan-3-one sodium bicarbonate, potassium bicarbonate, potassium bicarbonate/urea complex, or mono-ammonium phosphate. The dry chemical typically used for fire suppression is in certain embodiments non-aqueous. Dry chemical supply vessel 510 may be fluidly connected to dry chemical distribution nozzle 520 through dry chemical distribution piping 530. Dry chemical distribution nozzle 520 may be mounted within battery pods 130. In some embodiments, each battery pod 130 may include a dry chemical distribution nozzle 520. In other embodiments, each battery pod 130 may have a plurality of dry chemical distribution nozzles 520. FIG. 3 is a schematic depicting dry chemical distribution nozzles 520 in relation to ESS system 100. Further, as shown in FIG. 3 power electronics compartment 142 may include one or more dry chemical distribution nozzles 520 to suppress fires in support equipment, such as power electronics.

In certain embodiments, dry chemical spray subsystem 500 may be deployed to suppress fires occurring within battery pods 130, such as combustible materials other than battery cells, or in support systems, such as for power electronics. In such embodiments, water spray subsystem 200 may be used to suppress thermal runaway, as described above. Cooling battery cells 132 by spraying water onto them through sprinkler nozzles 210 may retard or stop thermal runaway.

In certain embodiments, controller 600 may control water spray subsystem 200 and dry chemical spray subsystem 500. For example, controller 600 may be electrically connected to sensors 610 within battery pods 130. Sensors 610 may detect fire or thermal runaway. For example, sensors 610 may be gas detection devices for pre-thermal runaway indication. When fire or gas is detected, controller 600 may activate dry chemical spray subsystem 500 to suppress the fire. When thermal runaway is detected, controller 600 may activate water spray subsystem 200.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A system comprising:
an energy storage system (ESS), the ESS including battery pods and one or more battery cells disposed within the battery pods;
an ESS trailer, the ESS mounted on the ESS trailer;
a water spray subsystem, the water spray subsystem including:
a plurality of sprinkler nozzles, the sprinkler nozzles mounted within the battery pods;
a first fluid connection, the first fluid connection fluidly connecting the sprinkler nozzles to a pump package; and
a second fluid connection, the second fluid connection fluidly connecting the pump package to a water storage supply; and
a dry chemical spray subsystem, the dry chemical spray subsystem including:
a dry chemical supply vessel, the dry chemical supply vessel mounted to the ESS trailer; and
a plurality of dry chemical distribution nozzles mounted within the battery pods, the dry chemical distribution nozzles fluidly connected to the dry chemical supply vessel by dry chemical distribution piping.

2. The system of claim 1, wherein the battery cells are lithium-ion batteries.

3. The system of claim 1, wherein the ESS further comprises power electronics mounted within a power electronics compartment.

4. The system of claim 1, wherein a dry chemical distribution nozzle is mounted within the power electronics compartment.

5. The system of claim 1, wherein the first fluid connection and the second fluid connection are hoses.

6. The system of claim 1, wherein the pump package includes a pump.

7. The system of claim 6, wherein the pump package is mounted on a pump package trailer.

8. The system of claim 7, wherein the water storage supply is a tank trailer.

9. The system of claim 1, wherein the dry chemical supply vessel includes a dry chemical, the dry chemical selected from the group consisting of sodium bicarbonate, potassium bicarbonate, potassium bicarbonate/urea complex, or mono-ammonium phosphate.

10. The system of claim 1 further including a controller, the controller adapted to activate the dry chemical subsystem, the water spray system, or both.

11. The system of claim 10, wherein the controller is electrically connected to a first set of sensors mounted within the battery pods.

12. The system of claim 11, wherein the controller is electrically connected to a second sensor mounted within a power electronics compartment.

13. The system of claim 10, wherein the controller is adapted to activate the dry chemical subsystem when the first set of sensors or the second sensor detects a fire.

14. The system of claim 10, wherein the controller is adapted to activate the water spray subsystem when the first set of sensors detects thermal runaway of one or more battery cells.
